(19) United States
(12) Patent Application Publication
(10) Pub. No.: US 2022/0226189 A1
(43) Pub. Date: Jul. 21, 2022

(54) MASSAGE APPARATUS

(71) Applicant: Mecca Sanders, Muskegon, MI (US)

(72) Inventor: Mecca Sanders, Muskegon, MI (US)

(21) Appl. No.: 17/580,864

(22) Filed: Jan. 21, 2022

Related U.S. Application Data
(60) Provisional application No. 63/140,033, filed on Jan. 21, 2021.

(51) Int. Cl. A61H 23/02; A61H 7/00

(52) U.S. Cl. CPC A61H 23/0263; A61H 2205/065; A61H 2201/165; A61H 7/003

(57) ABSTRACT

A massage apparatus includes a main body having a surface, a plurality of massage rollers coupled to the main body, a textured region disposed on at least a portion of the surface of the main body, and an electronic module disposed within the main body. The electronic module includes at least one of a heating mechanism, a cooling mechanism, and a thermoelectric module. The electronic module is configured to heat, cool, and/or selectively heat and cool the main body and the plurality of massage rollers via the heating mechanism, the cooling mechanism, and the thermoelectric module, respectively.

### CROSS-REFERENCE TO RELATED APPLICATIONS

This application claims priority to and the benefit of U.S. Provisional Application No. 63/140,033, filed on Jan. 21, 2021. The entire disclosure of the above application is incorporated herein by reference.

### FIELD

The present disclosure relates to exfoliation and massage therapy, and more particularly exfoliation and massage apparatuses.

### BACKGROUND

This section provides background information related to the present disclosure which is not necessarily prior art.

Feet are the foundation of mobility and are typically overworked and underappreciated.

The anatomy of the foot includes 26 bones, 33 joints, 42 muscles, and at least 50 ligaments and tendons, which are utilized to handle hundreds of tons of force every day; e.g., one's own weight in motion. As such, feet are at risk for injury and muscle fatigue, which can cause the feet and legs to feel sore, achy, and tired. Even more, feet are subjected to more pain from common problems such as bunions, corns and calluses, ingrown toenails, and toenail fungus. These problems can develop simply due to neglect and poor hygiene. For these reasons, it is important to practice good foot hygiene every day. This is especially important for individuals that have chronic health conditions, such as diabetes, poor circulation, and/or are elderly.

Measures for potentially preventing foot problems and managing pain include pedicures and massages. Pedicures are beauty treatments for the feet and toenails and can be done for cosmetic or therapeutic purposes. Pedicures are effective for eliminating dirt, bacteria, and odor from the feet and helping prevent nail diseases and disorders. Pedicures can also provide the opportunity to exfoliate. Exfoliation, e.g., sloughing off dead skin cells, removes the dead skin from the upper layer of the epidermis and reveals the healthy skin underneath. Removing dead skin cells encourages new skin cell growth which can keep the epidermis looking fresh. Other areas of the body, including the legs and feet, also benefit.

In addition to pedicures and exfoliation, massaging has many benefits as well. Foot massages have been commonly practiced for centuries and provide benefits that include improved blood flow and circulation. Blood flow can be limited when stress is present. A foot massage can be beneficial as it decreases stress and allows for unimpeded blood flow. In general, massages promote stimulation of the nervous system and enhance circulation. The pressure created by various massage techniques can move blood through congested areas of the body and release of massage pressure can cause new blood to flow into that area. Good circulation allows oxygen rich blood flow to damaged and/or tense muscles thereby promoting the healing process.

Although there are many different types of massages, in a basic sense, the term massage generally refers to pressing, rubbing, and/or manipulating the epidermis, muscles, tendons, and ligaments. In other words, a massage is the manipulation of the body's soft tissue generally given for the purpose of treating body stress or pain and resulting in physiological changes in the body through a relaxation response and a mechanical response. The relaxation response is an involuntary, yet predictable response of the nervous system. It is a state in which heart rate, breathing rate, blood pressure, and stress hormones are reduced and muscles are relaxed. Mechanical responses are physical effects that occur in the body when pressure is applied to soft tissues. As noted above, massages are believed to improve blood and lymph circulation, and improved circulation can enhance the delivery of oxygen and nutrients to muscle cells.

Massage techniques are commonly applied with the hands, fingers, elbows, knees, forearms, and feet of a massage therapist. With the advancement of technology, many devices or apparatuses have been created for assisting with a massage. Typical hand-held devices made of wood, plastic, or metal can be hard to hold in some circumstances, thereby becoming ineffective as the operator may have dexterity issues. Furthermore, typical hand-held devices can be unyielding to contoured areas of the foot such as high arches and heels. Hand-held devices are usually mechanical and unable to take advantage of the dexterity and flexibility of the human hand. Some hand-held devices may be battery operated costing the user over time as the batteries eventually need to be replaced. Other hand-held devices may have fragile or breakable parts and accessories, which also end up costing the end user over time.

In addition to hand-held devices, other foot massaging products can be large, bulky, and stationary. An example includes foot water bath massagers that are filled with water and require the user to place their feet within a tub. The tub can include one or more jets and massaging foot pads. In addition, foot massaging machines have also been utilized, which also require the user to place their feet in the machine and remain stationary. Undesirably, both solutions have been found to be too large and bulky. In addition, these solutions require a user to remain in a stationary and upright sitting position. Undesirably, this can prohibit flexibility and a re-positioning of the user.

There is a continuing need for a massage apparatus that can conform to a body of a patient, provide exfoliation, maximize the power of the dexterity and flexibility of the human hand, and increase performance quality to save time and money, which can be used in professional establishments and in personal settings.

### SUMMARY

In concordance with the instant disclosure, a massage apparatus that can conform to a body of a recipient, which can provide exfoliation, and which can maximize the power of dexterity and flexibility of the hand, has been surprisingly discovered.

In one embodiment, a massage apparatus includes a main body, a plurality of massage rollers, a textured region, and electronic module. The plurality of massage rollers can be coupled to the main body. The textured region can be disposed on at least a portion of the surface of the main body. The electronic module can be disposed within the main body and can include at least one of a heating mechanism, a cooling mechanism, and a thermoelectric module. The electronic module can be configured to heat, cool, and/or selectively heat and cool the main body and the plurality of massage rollers via the heating mechanism, the cooling mechanism, and the thermoelectric module, respectively.

In one example, the main body can include a handle defining a frustoconical shape. The handle can include a first end having a rounded convex surface and the plurality of massage rollers can be coupled to the rounded convex surface.

In another example, the main body can include a handle defining a frustoconical shape. The handle can include a first end having a rounded convex surface and a second end having a rounded convex surface, wherein the plurality of massage rollers can be coupled to the rounded convex surface of the first end and the rounded convex surface of the second end can include the textured region.

In other various examples, the main body can include a handle defining a flattened spherical shape and a top side having a rounded convex surface, wherein the plurality of massage rollers can be coupled to the rounded convex surface. The main body can include a strap having a first side and a second side, wherein the plurality of massage rollers can be coupled to the first side and the second side can include the textured region. The textured region can include a plurality of bristles, a plurality of abrasive elements, or a plurality of bristles and a plurality of abrasive elements.

In another embodiment, a massage apparatus includes a main body, a plurality of massage rollers, and electronic module. The main body can include a palm side, a dorsal side, an inner layer configured to encase a hand of a user, and an outer layer surrounding the inner layer. The plurality of massage rollers can be coupled to the outer layer of the palm side of the main body. The electronic module can be disposed on the palm side of the main body between the inner layer and the outer layer. The electronic module can include a heating element, a power source, and a controller, wherein the heating element follows a path proximate a perimeter of the main body between the inner layer and the outer layer, and the controller can be configured to permit the user to selectively provide power from the power source to the heating element.

In one example, the massage apparatus can further include a plurality of bristles and/or a plurality of abrasive elements disposed on at least one of the palm side and the dorsal side of the main body.

In a further example, the main body can include a digit portion having a thumb section, an index finger section, a middle finger section, a ring finger section, and a pinkie finger section. The heating element can follow the path through each one of the thumb section, the index finger section, the middle finger section, the ring finger section, and the pinkie finger section of the digit portion.

In another example, each one of the thumb section, the index finger section, the middle finger section, the ring finger section, and the pinkie finger section of the digit portion can include a distal phalanx portion and a proximal phalanx portion.

In another embodiment, a massage apparatus includes a main body, a plurality of massage rollers, a textured region, and electronic module. The main body can include a palm side, a dorsal side, and a digit portion, wherein the digit portion can include a thumb section, an index finger section, a middle finger section, a ring finger section, and a pinkie finger section. The plurality of massage rollers can be coupled to the palm side of the main body, wherein the plurality of massage rollers can include at least one massage roller can be coupled to each one of the thumb section, the index finger section, the middle finger section, the ring finger section, and the pinkie finger section of the digit portion. The textured region can be disposed on the dorsal side of the main body. The electronic module can be disposed in the palm side of the main body. The electronic module can include a power source, a controller, and a thermoelectric module can be configured to selectively heat and cool the main body and the plurality of massage rollers via a heating and cooling element extending throughout the palm side of the main body. The controller can be configured to permit a user to selectively provide power from the power source to the heating and cooling element.

In one example, each massage roller of the plurality of massage rollers can include a ball retention member and a ball rotationally secured in the ball retention member, wherein the ball retention member is embedded into the main body such that the ball retention member is not visible.

In another example, the palm side of the main body can include a palm area and the plurality of massage rollers can include at least one massage roller coupled to the palm area. The palm area can include three rows of massage rollers.

In another example, the plurality of massage rollers can include two massage rollers can be disposed along the thumb section, four massage rollers can be disposed along the index finger section and the pinkie finger section, and five massage rollers can be disposed along the middle finger section and the ring finger section.

In another example, textured region can include a plurality of bristles, a plurality of abrasive elements, or a plurality of bristles and a plurality of abrasive elements

In another example, the massage apparatus can include a textured region can be disposed on the distal phalanx portion of the thumb section, the index finger section, the middle finger section, the ring finger section, and the pinkie finger section on the palm side of the main body.

Further areas of applicability will become apparent from the description provided herein.

It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front plan view of a massage apparatus according to one embodiment of the present disclosure, depicting a main body as a glove;

FIG. 2 is a rear plan view of the massage apparatus shown in FIG. 1, depicting a plurality of abrasive elements disposed on a dorsal side of the glove;

FIG. 3 is a perspective view of a massage roller according to the present disclosure;

FIG. 4 is a cross-sectional view of the massage roller of FIG. 3;

FIG. 5 is a side view of a finger portion of a massage apparatus depicting massage rollers embedded in the finger portion according to the present disclosure;

FIG. 6 is a side cross-sectional view of a finger portion of a massage apparatus depicting massage rollers coupled to a surface of the finger portion according to the present disclosure;

FIG. 7 is a front plan view of the massage apparatus shown in FIG. 1, with an outer layer removed, and further showing an electronic module;

FIG. 8 is a schematic diagram of electronic components of a massage apparatus according to the present disclosure;

FIG. 9 is a perspective view of a massage apparatus according to another embodiment of the present disclosure, depicting a main body as a handle having a frustoconical shape;

FIG. 10 is a perspective view of a massage apparatus according to another embodiment of the present disclosure, depicting a main body as a handle having a flattened spherical shape;

FIG. 11 is a perspective view of a massage apparatus according to another embodiment of the present disclosure, depicting a main body as an electronic mouse;

FIG. 12 is a front plan view of a massage apparatus according to another embodiment of the present disclosure, depicting a main body as an elongated strap; and

FIG. 13 is a rear plan view of the massage apparatus of FIG. 12.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

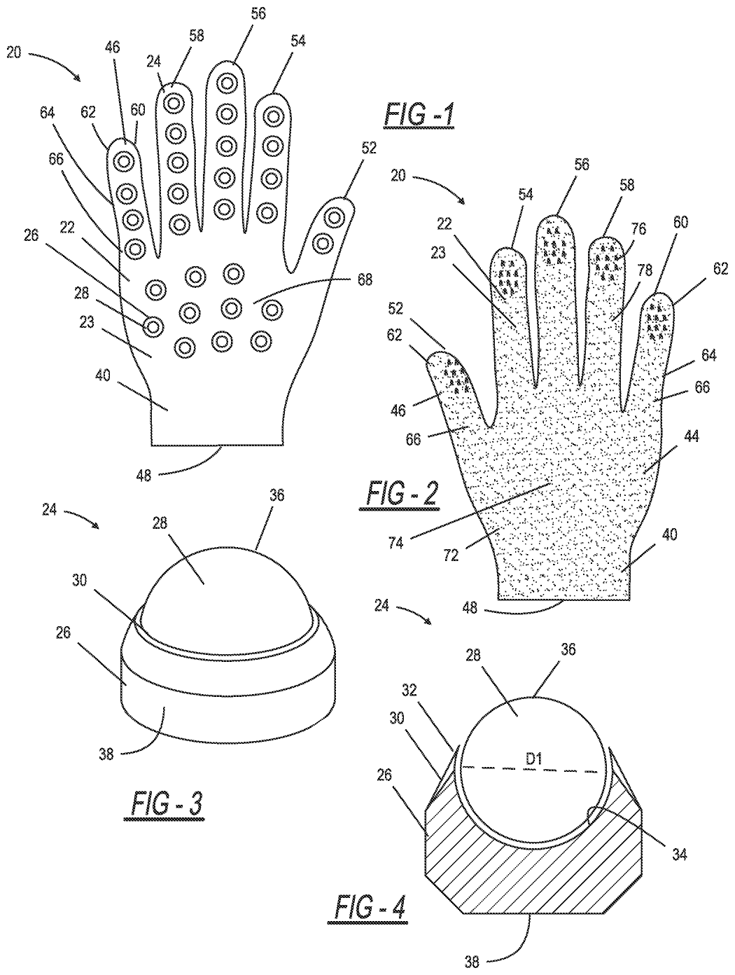

Referring to FIGS. 1-2, a massage apparatus 20 for massaging various portions of a body of a recipient is shown. The massage apparatus 20 can include a main body 22 and one or more massage rollers 24 coupled to the main body 22. The main body 22 can be configured to be held by a user (e.g., a masseuse, physical therapist, etc.) or fit on a hand of the user to permit the massage apparatus 20 to be used while the recipient (e.g., a patient or the user themselves) is sitting, standing, lying down, or in any other position that benefits the recipient.

The main body 22 can be manufactured from various materials or combinations of materials, such as for example, rubber, silicone, spandex, plastic, steel, and wood, among others. However, it should be appreciated that a skilled artisan can manufacture the main body 22 from materials that can insulate heat and cold, and materials that are flexible enough to bend and conform to the body of the recipient and dexterity of the hand. The material can provide thermal insulation and/or thermal retention, including where the material minimizes the transfer of heat to/from the recipient or where the material can operate as a heat source or heat sink to maximize the transfer of heat to/from the recipient.

The massage rollers 24 are coupled to at least a portion of a surface 23 of the main body 22 and can be configured to contact and roll directly on the epidermis of the recipient. Alternatively, the massage rollers 24 can be configured to contact and roll indirectly on the epidermis of the recipient. For example, the epidermis of the recipient can be covered by a material, such as clothing or a towel, in which case, the massage rollers 24 make contact with and roll on the material, and thus the epidermis of the recipient indirectly. The rolling of each massage roller 24, when combined with the pressure being exerted by the user, can provide localized pressure producing a massaging effect for muscle relaxation for the muscles of the recipient. Action of the massage rollers 24 and/or the pressure by the user may further provide improved circulation for the body of the recipient.

Referring to FIGS. 3-4, each massage roller 24 can include a ball retention member 26 and a ball 28 rotationally secured in the ball retention member 26 such that the ball 28 can freely rotate in any direction. In other words, the ball 28 has a 360-degree freedom of rotation when the ball 28 is secured in the ball retention member 26. The ball retention member 26 can include an upper portion 30 defining an aperture 32 and an inner surface 34 defining a generally hemi-spherical shape corresponding to a shape of an outer surface 36 of the ball 28. The inner surface 34 can taper inwardly toward the upper portion 30 of the ball retention member 26 to facilitate retention of the ball 28. The ball 28 can define a diameter D1 permitting the ball to project through the aperture 32 of the ball retention member 26 while the tapered upper portion 30 of the ball retention member 26 inhibits the ball 28 from fully passing through the aperture 32. In one example, the diameter D1 of the ball 28 can be between 0.5 millimeters to 76.2 millimeters. It should be appreciated that a person skilled in the art may scale the diameter of each ball, as desired, while remaining within the scope of this disclosure.

The ball 28 can be manufactured from various materials or combinations of materials, such as, steel, ceramic, glass, plastic, and wood, among others.

The ball retention member 26 can further include a bottom portion 38 configured to engage with a surface of the main body 22 to couple the massage roller 24 to the main body 22. As shown in FIG. 4, the bottom portion 38 of the ball retention member 26 can be substantially flat to engage with a surface 23 of the main body 22. However, it should be appreciated that a skilled artisan can scale the shape and/or size of the ball retention member to conform to a shape and/or size of the main body 22.

Referring back to FIGS. 1-2, the main body 22 can include a glove 40. The glove 40 can be worn on a hand of the user to massage the recipient, e.g., someone other than the user, such as a patient, or the user themselves. Desirably, this permits the user to use the full dexterity of the hand. It is believed that the use of the human hand permits greater control over the movement, direction, and pressure being exerted on the recipient during a massage.

The glove 40 can be manufactured from various materials or combinations thereof, including rubber, silicon, latex, spandex, nylon, or any other material suitable for comfortable wear of the user. The glove 40 can come in different sizes and/or be stretchable to conform to different sized hands. In certain examples, the glove 40 is washable, which can permit the glove to be washed and reused, for example, the glove 40 can be washed after use on one patient and reused on the next patient.

The glove 40 includes a palm side 42 (FIG. 1), a dorsal side 44 (FIG. 2), a digit portion 46, and a receiving portion 48 defining an opening configured to receive the hand of the user. In operation, the user inserts a hand into the receiving portion 48 until the hand is enclosed within the glove 40. When the hand is enclosed within the glove 40, digit portion 46 encases the fingers of the hand. The digit portion 46 can include a thumb section 52, an index finger section 54, a middle finger section 56, a ring finger section 58, and a pinkie finger section 60. Each one of the index finger 54, middle finger 56, ring finger 58, and pinkie finger 60 sections can include a distal phalanx portion 62, a middle phalanx portion 64, and a proximal phalanx portion 66. The thumb section 52 can include the distal phalanx portion 62 and the proximal phalanx portion 66.

As shown in FIG. 1, the palm side 42 of the glove 40 can include the plurality of massage rollers 24. The massage rollers 24 can be disposed on at least one of a palm area 68 and at least one section 52, 54, 56, 58, 60 of the digit portion 46. Desirably, this can allow the user to easily manipulate the massage rollers 24 by moving the hand. In addition, it is believed that disposing the massage rollers 24 on the palm side 42 of the glove 40 permits the user to easily exert pressure on the epidermis of the recipient.

In the example shown in FIG. 1, the palm side 42 of the glove 40 includes a plurality of massage rollers 24 disposed on the palm area 68, the thumb section 52, the index finger section 54, the middle finger section 56, the ring finger section 58, and the pinkie finger section 60.

More specifically, the palm area 68 can include three rows of massage rollers 24 wherein the top and bottom row each includes three massage rollers 24 and the middle row includes four massage rollers 24. The thumb section 52 can include two massage rollers 24 disposed along the distal phalanx portion 62 and the proximal phalanx portion 66. The index finger section 54 and the pinkie finger section 60 can include four massage rollers 24 disposed along the distal phalanx portion 62, the middle phalanx portion 64, and the proximal phalanx portion 66. The middle finger section 56 and the ring finger section 58 can include five massage rollers 24 disposed along the distal phalanx portion 62, the middle phalanx portion 64, and the proximal phalanx portion 66.

It should be appreciated that a skilled artisan can scale the number, size, and location of the massage rollers 24, as desired. In nonlimiting examples, the massage rollers 24 can be coupled to the dorsal side 44 as opposed to the palm side 42 or coupled to both the palm side 44 and the dorsal side 44. Where the massage rollers 24 are disposed on the digit portion 46, the massage rollers 24 can be disposed along the distal phalanx portion 62, but not the proximal phalanx portion 66, or vice-versa. The massage rollers 24 can be disposed along at least two of the distal phalanx portion 62, the middle phalanx portion 64, and the proximal phalanx portion 66. Other nonlimiting examples include:
(a) massage rollers 24 disposed on the palm area 68, but not the digit portion 46;
(b) massage rollers 24 disposed on the digit portion 46, but not the palm area 68;
(c) massage rollers 24 disposed on at least one of the index finger section 54, the middle finger section 56, the ring finger section 58, and the pinkie finger section 60, but not the thumb section 52 or the palm area 68;
(d) massage rollers 24 disposed on the thumb section 52 and at least one of the index finger section 54, the middle finger section 56, the ring finger section 58, and the pinkie finger section 60, but not the palm area 68;
(e) massage rollers 24 disposed on the palm area 68 and the thumb portion 52, but not the index finger section 54, the middle finger section 56, the ring finger section 58, or the pinkie finger section 60; and
(f) massage rollers 24 disposed on the palm area 68 and at least one of the index finger section 54, the middle finger section 56, the ring finger section 58, and the pinkie finger section 60, but not the thumb section 52.

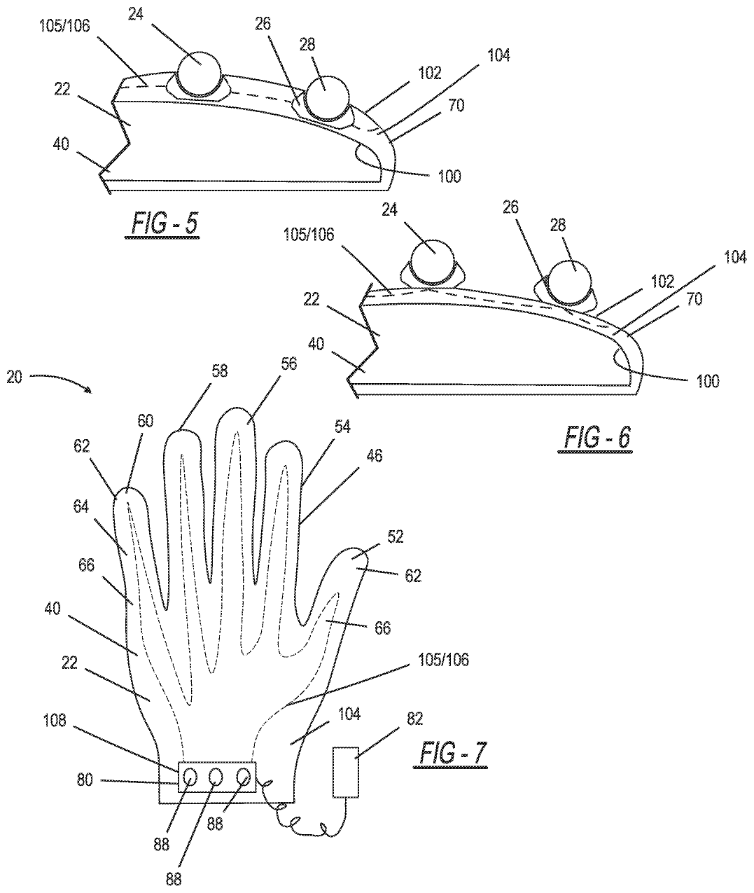

Referring to FIG. 5, each massage roller 24 can be coupled to the glove 40 such that each massage roller 24 is embedded into the glove 40. As shown in FIG. 5, the ball retention member 26 can be disposed within an outer layer 70 on the palm side 42 of the glove 40 such that the ball retention member 26 is not visible and the ball 28 is visible.

Referring to FIG. 6, the ball retention member 26 can be coupled to the outer layer 70 of the palm side 42 of the glove 40. In this example, the substantially flat bottom portion 38 of the ball retention member 26 engages with the outer layer 70 such that a portion of or the entire ball retention member 26 is visible.

The ball retention member 26 can be coupled to the glove 40 via sewing and/or adhesion. It should be appreciated that a skilled artisan may employ any coupling method known in the art, as desired.

As shown in FIG. 2, the glove 40 can include a textured region 72 configured to produce massaging effects to the recipient and/or to exfoliate the epidermis of the recipient. The textured region 72 can be configured to be disposed on at least a portion of a surface 23 of the main body 22. In various examples, the textured region 72 can be disposed on the palm side 42 of the glove 40, and more specifically, the textured region 72 can disposed on the distal phalanx portion 62 of each section 52, 54, 56, 58, 60 of the digit portion 46. Advantageously, with this configuration, the textured region 72 can be manipulated by the fingers of the user. The textured region 72 can be disposed on the palm area 68 of the glove thereby allowing the user to manipulate the textured region 72 by movement of the hand of the user. The textured region 72 can be disposed on the dorsal side 44 of the glove 40; e.g., on at least one of a back area 74 and at least one section 52, 54, 56, 58, 60 of the digit portion 46. Advantageously, with this configuration, the user can simply rotate their hand to use the textured region 72 on the recipient.

In one example, the textured region 72 can include a plurality of bristles 76 configured to produce additional massaging effects to the recipient. The size and/or shape of each bristle 76 can be the same over the textured region 72 or can include more than one size and/or shape distributed over the textured region 72. As shown in FIG. 2, each bristle 76 can define an elongated body, and the plurality of bristles 76 can be distributed over a textured region 72 on the distal phalanx portion 62 of each section 52, 54, 56, 58, 60 of the digit portion 46. Desirably, this permits the bristles 76 to be manipulated by fingers of the user. It should be appreciated that a skilled artisan may scale the location of the bristles 76, as desired.

The plurality of bristles 76 can be made of a soft elastic material, metal, and/or plastic, among other materials known in the art suitable to provide a massaging effect. It should be appreciated that a skilled artisan may scale the size, shape, density, and distribution of the bristles 76, as desired. For example, the dorsal side 44 of the glove 40 can include the plurality of bristles 76 distributed over the entire back area 74, but not the digit portion 46, and vice versa. In a further example, the glove 40 can include the plurality of bristles 76 distributed over the back area 74 and entire the digit portion 46.

In another example, the textured region 72 can include a plurality of abrasive elements 78 configured to provide exfoliation by scrapping away dead skin cells of the recipient. The plurality of abrasive elements 78 can be disposed on at least one of the back area 74 of the dorsal side 44 and at least one section 52, 54, 56, 58, 60 of the digit portion 46. The plurality of abrasive elements 78 can be configured to provide exfoliation by scrapping away dead skin cells of the recipient. Nonlimiting examples of the plurality of abrasive elements 78 can include flexible wet abrasives and/or flexible dry abrasives. The plurality of abrasive elements 78 can have a grit rating, wherein the grit rating can be selected based on the desired rate of skin removal, amount of skin removal, and/or condition of the skin being removed. The plurality of abrasive elements 78 can include a grit rating that is substantially the same across the textured region 72 or can include a grit rating that varies across the textured region 72. In certain examples, the grit rating can be between 220 grit and 1200 grit. It should be appreciated that one skilled in the art can select different grit ratings, as desired.

The dorsal side 44 of the glove 40 can include more than one textured region 72, wherein at least one textured region 72 includes the plurality of bristles and at least one textured region 72 includes the plurality of abrasive elements 78. In a nonlimiting example, as shown in FIG. 2, the dorsal side 44 includes the plurality of abrasive elements 78 disposed on the back area 74, the proximal phalanx portion 66 of each section 52, 54, 56, 58, 60 of the digit portion 46, and the middle phalanx portion 64 of the index finger section 54, the middle finger section 56, the ring finger section 58, and the pinkie finger section 60; and further includes the plurality of bristles disposed on the distal phalanx portion 62.

It should be appreciated that a skilled artisan can scale the number and location of the textured region 72, as desired. Furthermore, it should be appreciated that although the textured region 72 is shown disposed on the dorsal side 44 of the glove 40, one skilled in the art may provide a glove 40 having a textured region 72 disposed on the palm side 42 or disposed on both the dorsal side 44 and the palm side 42 while remaining within the scope of the present disclosure.

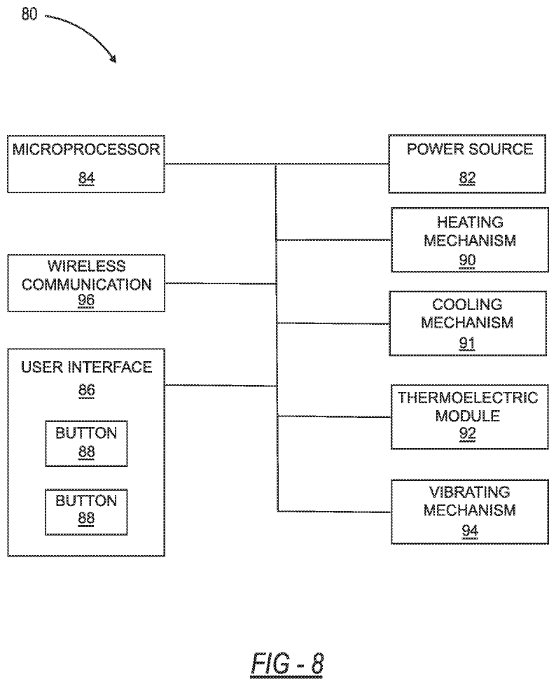

Referring to FIGS. 7-8, the massage apparatus 20 can further include an electronic module 80 configured to generate at least one of heat, cold, vibration, and a combination thereof through the main body 22 and/or the massage roller 24. Advantageously, the heat, the cold, and the vibration can aid in providing muscle relaxation and improve blood circulation in various applications to the recipient. The electronic module 80 can be coupled to the main body 22. In one example, the electronic module 80 can be disposed within the massage apparatus 20, which is described in greater detail below.

The electronic module 80 can include a power source 82, a microprocessor 84 electrically connected to the power source 82, and at least one controller 86, e.g., a user control. The electronic module 80 further includes at least one of a heating mechanism 90, a cooling mechanism 91, a thermoelectric module 92, and a vibrating mechanism 94 based on which features the massage apparatus 20 provides (e.g., heating, cooling, and/or vibration). The thermoelectric module 92 can be configured to selectively heat and cool the main body 22 and/or the massage rollers 24 of the massage apparatus 20 via a heating and cooling element 105 extending throughout the palm side 42 of the glove 40. The vibrating mechanism 94 is configured to provide vibration to the massage apparatus 20.

The microprocessor 84 can be configured to activate and deactivate the heating mechanism 90, the cooling mechanism 91, the thermoelectric module 92, and/or the vibrating mechanism 94. The controller 86 can include one or more user inputs 88 configured to permit the user to selectively control the temperature, vibration and/or power of the massage apparatus 20. In one example, the one or more user inputs 88 include a button.

The power source 82 can be configured to provide power to the various components of the electronic module 80. In one example, the power source 82 can include a rechargeable battery, such as a lithium polymer battery, disposed in the main body 22. It should be appreciated that a skilled artisan may employ other suitable rechargeable batteries, such as a lead-acid battery or nickel-cadmium (NiCad) battery, as desired. The massage apparatus 20 can be configured to recharge the battery using wireless charging capabilities.

Furthermore, it should be appreciated that a skilled artisan may scale the number of power sources or select other suitable power sources while still remaining within the scope of the disclosure. Nonlimiting examples can include a power source 82 that is internal or external to the massage apparatus 20, such as a battery, an energy-storing microchip, solar energy, an electrical cord plugged into a standard wall socket, and/or a wired connection to a power source 82.

The electronic module 80 can further include a wireless communication protocol 96 adapted to provide communication between the microprocessor 84, by way of a transmitter, receiver, or transceiver, and an external device, such as a mobile phone, computer, tablet, or the like. For example, the microprocessor 84 can be in communication with or have included with it a transceiver such as a Bluetooth radio transceiver for communication to the external device. In a specific example, the massage apparatus 20 communicates with the external device using Bluetooth Low Energy Protocol (BLE). It should be appreciated that a skilled artisan may use other wireless communication protocols, such as for example, ANT, Zigbee, LoRa and/or LoRaWAN, while remaining within the scope of the present disclosure. It should be appreciated that a skilled artisan can employ other features and structures for the electronic module 80, within the scope of this disclosure.

Referring back to FIGS. 5-7, where the main body 22 includes the glove 40, the electronic module 80 can be disposed between layers of the glove 40. As such, the glove 40 can include an inner layer 100 configured to encase the hand of the user, an outer layer 102 configured to surround the inner layer 100 and form the outer layer of the glove 40, and a middle layer 104 disposed between the inner layer 100 and the outer layer 102. As shown in FIG. 7, the electronic module 80 can be disposed between the inner layer 100 and outer layer 102 on the palm side 42 of the glove 40.

In one nonlimiting example, the electronic module 80 further includes a housing 108 configured to house components of the electronic module 80, the heating mechanism 90 and the vibrating mechanism 94. The heating mechanism 90 can include an elongated heating element 106 formed from an electrically conductive material and electrically coupled to the power source 82. The heating element 106 can be secured between the inner layer 100 and outer layer 102 of the main body 22 such that the heating element 106 follows a path proximate a perimeter of the main body 22. The heating element 106 can be secured in the middle layer 104 of the glove 40 and follow a path beginning at the housing 108, extending towards the digit portion 46, run through each section 52, 54, 56, 58, 60 of the digit portion 46, and ending at the housing 108. With this configuration, the heat generated can be uniformly distributed throughout the glove 40.

As best shown in FIGS. 5-6, the heating element 106 can be disposed in the glove 40 such that the heating element 106 engages with and heats the massage rollers 24. The heating element 106 can be configured to engage with and heat some or all the massage rollers 24. It should be appreciated that a skilled artisan may scale the location and path of the heating element 106, as desired. In operation, the user can selectively provide power from the power source 82 to the heating element 106 via the controller 86.

As discussed above, the main body 22 can be manufactured from materials that provide insulation. Desirably, the insulation can protect the user from the heat or the cold. In some examples, the heat, the cold, and/or the vibration can be adjusted by the user according to the needs of the recipient. In other examples, the heat, the cold, and/or the vibration are set at default values that have been shown to be useful for recipients during a massage.

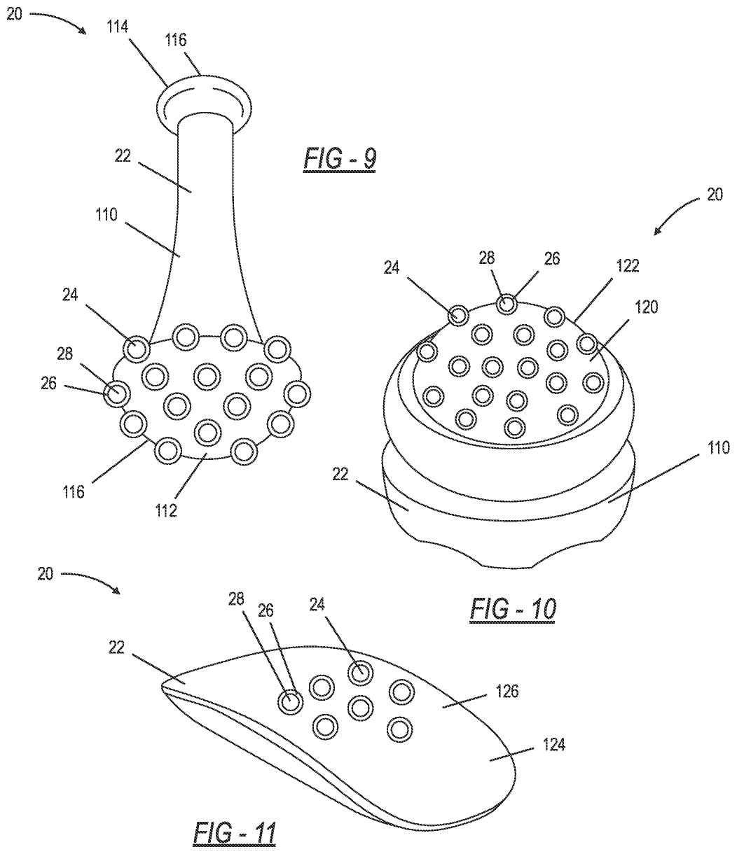

Referring to FIGS. 9-10, the main body 22 of the massage apparatus 20 can include a handle 110. The handle 110 can define a shape that permits the user to grip the handle 110 while providing ergonomic comfort for the user. In the example shown in FIG. 9, the handle 110 defines a frustoconical shape. The handle 110 includes a first end 112 and a second end 114. Each one of the first end 112 and the second end 114 can include a structure having a metal or metal alloy. The metal or metal alloy can include one or more various bronzes, including alloys of copper and tin, as well as having additional metals such as aluminum, manganese, nickel, and/or zinc. Advantageously, the metal's alkaline properties are believed to naturally balance pH levels of the epidermis, revitalize, and plump the epidermis, soften fine lines, and facilitate muscle relaxation and improved blood circulation in various applications to the recipient.

The first end 112 and the second end 114 can be different sizes, have different surface geometries including different curvatures, texturing, protrusions, and/or recesses. For example, one end 112, 114 can be configured to provide a massaging surface without exfoliation and the other end 112, 114 can be configured to provide a massaging surface with exfoliation. As such, the respective surface of one end 112, 114 can be generally smooth to permit the massage apparatus 20 to slide across the skin, whereas the respective surface of the other end 112, 114 can also include the texture region 72 having the bristles 76 and/or the abrasive elements 78 that provides the messaging and/or exfoliating action when the massage apparatus 20 is moved across the epidermis. Alternatively, the first end 112 and the second end 114 can be substantially the same size, have substantially the same surface geometries including substantially the same curvatures, texturing, protrusions, and/or recesses.

In one specific example, as shown in FIG. 9, the first end 112 can define a diameter that is greater than a diameter of a second end 114. The first end 112 can include a rounded convex surface 116 and the plurality of massage rollers 24 coupled to the rounded convex surface 116. The ball 28 of each massage roller 24 can be a metal or metal alloy, such as one or more various bronzes, alloys of copper and tin, aluminum, manganese, nickel, and/or zinc. The first end 112 can further include the textured region 72 disposed on the rounded convex surface 116 to produce additional massaging effects and/or to exfoliate the epidermis of the recipient. The second end 114 can include a rounded convex surface 118. The second end 114 can include the plurality of massage rollers 24 and/or the textured region 72. However, it should be noted that embodiments also include where both ends are configured with the same or different degrees of smoothness or geometries, as well as where both ends are configured with the same or different degrees of texture or abrasiveness to provide exfoliation. The electronic module 80 can be disposed in the frustoconical shaped handle 110 such that the electronic module 80 can generate at least one of heat, cold, vibration, and a combination thereof at the first end 112 and/or the second end 114.

In the example shown in FIG. 10, the handle 110 defines a flattened spherical shape. The handle 110 can include a top side 120 having a rounded convex surface 122 and the plurality of massage rollers 24 coupled to the rounded convex surface 122. The handle 110 can include the textured region 72 disposed on the rounded convex surface 122 to produce additional massaging effects and/or to exfoliate the epidermis of the recipient. The electronic module 80 can be disposed in the flattened spherical handle 110 to generate heat, cold, and/or vibration.

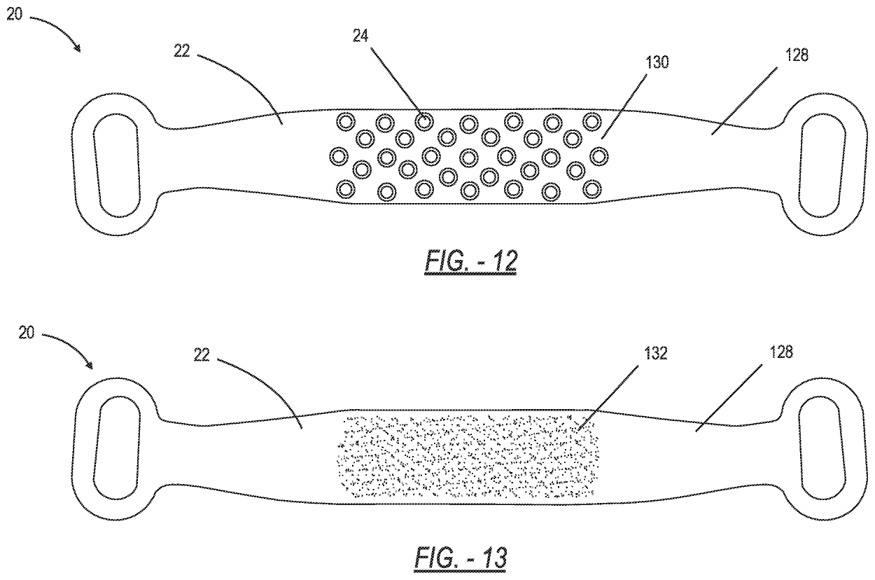

Referring to FIG. 11, the main body 22 of the massage apparatus 20 can include a computer mouse shape 124 defining a contour surface 126. The computer mouse shape can be designed to be held by the user to permit the user to use the full dexterity of the hand. It is believed that the contour surface 126 can provide ergonomic comfort for the user. However, it should be appreciated by one skilled in the art that the contour surface 126 can be formed into different ergonomic designs, within the scope of this disclosure. The computer mouse shape 124 can include the plurality of massage rollers 24 coupled to the contour surface 126. The computer mouse shape 124 can include the electronic module 80 disposed beneath the contour surface to generate heat, cold, and/or vibration.

The computer mouse shape 124 can be comprised of memory foam. In certain examples, at least a portion of the main body 22 can be filled with memory foam. Desirably, the memory foam can conform the main body 22 to the hand of the user. It should be appreciated that the main body 22 can also be comprised of expanded polystyrene (EPS) microbeads. Like the memory foam, the EPS microbeads can permit the main body 22 to be flexible and conform to the body of the user. In certain examples, the EPS microbeads can be disposed on the contour surface 126 in a grid design. This can permit the EPS microbeads to act as a massage element. In particular, the EPS microbeads can actively shape to the body of the recipient, thereby providing reactive support. In other instances, the textured region 72 can be disposed on the contour surface 126. Desirably, this can permit exfoliation while the user is being massaged.

Referring to FIGS. 12-13, the main body 22 of the massage apparatus 20 can include a strap 128. The strap 128 can be configured to be manipulated by one or both hands of the user. Desirably, the strap 128 can permit the user to use the full dexterity of one or both hands. Pressure can be adjusted by releasing or tightening the users grip on the strap 128. It should be appreciated that one skilled in the art can employ other types of structures for the main body 22, as desired. The strap 128 can include a first side 130 and a second side 132. The first side 130 can include the plurality of massage rollers 24 and/or the textured region 72. Likewise, the second side 132 can include the plurality of massage rollers 24 and/or the textured region 72.

In one specific example, as shown in FIGS. 12-13, the first side 130 of the strap 128 includes the plurality of massage rollers 24 and the second side 132 includes the textured region 72. Advantageously, this configuration provides a massage apparatus that can conform to the body of the recipient and further permit the user to use the strap 128 to roll the massage rollers 24 across the epidermis on the recipient. In addition, like the glove 40, this location can permit the user to easily exert pressure on the epidermis of the recipient. Furthermore, this configuration permits the user to simply flip the strap 128 to use the textured region 72 on the second side 132 for exfoliation.

Advantageously, the massage apparatus 20 can conform to the body of the recipient. The various embodiments of the massage apparatus 20, including the glove 40, the handle 110, the computer mouse shape 124, and the strap 128 can each conform to the body of the recipient.

While certain representative embodiments and details have been shown for purposes of illustrating the invention, it will be apparent to those skilled in the art that various changes can be made without departing from the scope of the disclosure, which is further described in the following appended claims.

What is claimed is:

1. A massage apparatus, comprising:
a main body including a surface;
a plurality of massage rollers coupled to the main body;
a textured region disposed on at least a portion of the surface of the main body; and
an electronic module disposed within the main body, the electronic module including at least one of a heating mechanism, a cooling mechanism, and a thermoelectric module, wherein the electronic module is configured to at least one of heat, cool, and selectively heat and cool the main body and the plurality of massage rollers via the heating mechanism, the cooling mechanism, and the thermoelectric module, respectively.

2. The massage apparatus of claim 1, wherein the main body includes a handle defining a frustoconical shape.

3. The massage apparatus of claim 2, wherein the handle includes a first end having a rounded convex surface and the plurality of massage rollers are coupled to the rounded convex surface.

4. The massage apparatus of claim 2, wherein the handle includes a first end having a rounded convex surface and a second end having a rounded convex surface, wherein the plurality of massage rollers are coupled to the rounded convex surface of the first end and the rounded convex surface of the second end includes the textured region.

5. The massage apparatus of claim 1, wherein the main body includes a handle defining a flattened spherical shape and a top side having a rounded convex surface, wherein the plurality of massage rollers are coupled to the rounded convex surface.

6. The massage apparatus of claim 1, wherein the main body includes a strap having a first side and a second side, wherein the plurality of massage rollers are coupled to the first side and the second side includes the textured region.

7. The massage apparatus of claim 1, wherein the textured region includes a plurality of bristles, a plurality of abrasive elements, or a plurality of bristles and a plurality of abrasive elements.

8. A massage apparatus for use by a hand of a user, comprising:
a main body including a palm side, a dorsal side, an inner layer configured to encase the hand of the user, and an outer layer surrounding the inner layer;
a plurality of massage rollers coupled to the outer layer of the palm side of the main body; and
an electronic module disposed on the palm side of the main body between the inner layer and the outer layer, the electronic module including a heating element, a power source, and a controller, wherein the heating element follows a path proximate a perimeter of the main body between the inner layer and the outer layer, and the controller is configured to selectively provide power from the power source to the heating element.

9. The massage apparatus of claim 8, further including a plurality of bristles disposed on at least one of the palm side and the dorsal side of the main body.

10. The massage apparatus of claim 8, further including a plurality of abrasive elements disposed on at least one of the palm side and the dorsal side of the main body.

11. The massage apparatus of claim 8, wherein the main body includes a digit portion having a thumb section, an index finger section, a middle finger section, a ring finger section, and a pinkie finger section.

12. The massage apparatus of claim 11, wherein the heating element follows the path through each one of the thumb section, the index finger section, the middle finger section, the ring finger section, and the pinkie finger section of the digit portion.

13. The massage apparatus of claim 11, wherein each one of the thumb section, the index finger section, the middle finger section, the ring finger section, and the pinkie finger section of the digit portion includes a distal phalanx portion and a proximal phalanx portion.

14. The massage apparatus of claim 13, further including a textured region disposed on the distal phalanx portion of the thumb section, the index finger section, the middle finger section, the ring finger section, and the pinkie finger section on the palm side of the main body.

15. A massage apparatus for use by a hand of a user, comprising:
a main body including a palm side, a dorsal side, and a digit portion, wherein the digit portion includes a thumb section, an index finger section, a middle finger section, a ring finger section, and a pinkie finger section;
a plurality of massage rollers coupled to the palm side of the main body, wherein the plurality of massage rollers includes at least one massage roller coupled to each one of the thumb section, the index finger section, the middle finger section, the ring finger section, and the pinkie finger section of the digit portion; and
a textured region disposed on the dorsal side of the main body; and
an electronic module disposed in the palm side of the main body, the electronic module including a power source, a controller, and a thermoelectric module configured to selectively heat and cool the main body and the plurality of massage rollers via a heating and cooling element extending throughout the palm side of the main body,
wherein the controller is configured to selectively provide power from the power source to the heating and cooling element.

16. The massage apparatus of claim 15, wherein each massage roller of the plurality of massage rollers includes a ball retention member and a ball rotationally secured in the ball retention member, wherein the ball retention member is embedded into the main body such that the ball retention member is not visible.

17. The massage apparatus of claim 15, wherein the palm side of the main body includes a palm area and the plurality of massage rollers includes at least one massage roller coupled to the palm area.

18. The massage apparatus of claim 17, wherein the palm area includes three rows of massage rollers.

19. The massage apparatus of claim 17, wherein the plurality of massage rollers includes two massage rollers disposed along the thumb section, four massage rollers disposed along the index finger section and the pinkie finger section, and five massage rollers disposed along the middle finger section and the ring finger section.

20. The massage apparatus of claim 15, wherein the textured region includes a plurality of bristles, a plurality of abrasive elements, or a plurality of bristles and a plurality of abrasive elements.
